(19) United States
(12) Patent Application Publication
(10) Pub. No.: US 2011/0182478 A1
(43) Pub. Date: Jul. 28, 2011

(54) PROCESS OF SELECTING STEM SEGMENTS

(75) Inventors: Evaristo Luiz Momesso, JR., Sao Paulo (BR); Jakob Andreas Leuenberger, Basel (CH); Markus Roggli, Stein (CH); Jose Giraldo Martins Dos Santos, Sao Paulo (BR)

(73) Assignee: SYNGENTA CROP PROTECTION, INC., Greensboro, NC (US)

(21) Appl. No.: 12/867,425

(22) PCT Filed: Feb. 13, 2009
(86) PCT No.: PCT/EP2009/001015

§ 371 Date: Apr. 6, 2011

(30) Foreign Application Priority Data
Feb. 15, 2008 (GB) 0802849.0

(51) Int. Cl. G06K 9/00

(52) U.S. Cl. 382/110

(57) ABSTRACT

The invention refers to a method of selecting stem segments with desired characteristics and more specifically the invention refers to a method of selecting stem segments of graminaceous plants (from the Gramineae/Poaceae family), such as plants of the Saccharum spp, including sugar cane. According to an embodiment of the invention, the method of selecting stem segments, comprises the steps of identifying at least one characteristic of each stem segment by a sensor; and separating the stem segments comprising the said characteristic from those which do not comprise the said characteristic, depending on the response of said identification means; characterized in that the sensor is selected from the group consisting of a pressure transducer sensor, a capacitive sensor, an ultrasound sensor, an x-ray sensor, a magnetic sensor, and a microwave sensor.

### FIELD OF THE INVENTION

The invention refers to a method of selecting stem segments with desired characteristics and more specifically the invention refers to a method of selecting stem segments of graminaceous plants (from the Gramineae/Poaceae family), such as plants of the Saccharum spp, including sugar cane.

### DEFINITIONS

For the specification below and attached claims, the current definitions are used:

Stem: the caulis or stalk of the culm part of a graminaceus plant, i.e. the main trunk of a plant, specifically a primary plant axis that develops buds and shoots.

Sett: a stem segment, section or cutting having one or more nodes.

Node: the location in the stem where the bud or gemma is formed in a graminaceus plant.

Bud or gemma: the embryo, spore or germ of a graminaceus plant.

Germinate/germination: the emergence of a new plant from a bud.

### BACKGROUND OF THE INVENTION

Graminaceous plants (of the Gramineae/Poaceae family), are usually formed by a stem which comprises several nodes and internodes along its length. The node comprises the bud (or gemma) of the plant, that may be used to yield a new plant, e.g. for a crop.

Examples of graminaceous plants includes bamboos (Bambusoideae, such as Phyllostachys spp, and Arundinaria spp), sugar cane (Saccharum spp), and other grasses (such as elephant-grass (Pennisetum purpureum).

In the case of sugar cane, particularly, it is being highlighted by the media as an alternative to fossil fuels, as the alcohol obtained by the fermentation of such plants appears to be the promise of a renewable and clean fuel. The plantation area of sugar cane is increasing worldwide as well as the investments in factories to produce alcohol.

The seed of sugar cane is a dry one-seeded fruit or caryopsis formed from a single carpel, the ovary wall (pericarp) being united with the seed-coat (testa). The seeds are ovate, yellowish brown and very small, about 1 mm long.

However, the seed of sugar cane only germinates under specific environmental characteristics, such as a constant warm and humid climate conditions. Such climatic conditions are not found everywhere that sugar cane is grown, and therefore germination of sugar cane seed is not always guaranteed. For commercial agriculture, the seed of a sugar cane is not sown or planted, but rather the cane is propagated vegetatively by planting a stem segment (or part of a stalk or culm or seedling). As mentioned above, the stem of sugar cane, as well as the stem of graminaceous plants, comprises several nodes, from which new plants grow.

The traditional planting process of sugar cane involves the reservation of an area of the crop to be used as a source of plants for re-planting, since the nodes are comprised in the stem. The plants used for re-planting are harvested and then cut in segments of approximately 20-50 cm so that at least 2 nodes are present in each stem segment (sett). Cutting the stems is needed to break apical dominance that otherwise causes poor germination when using full length (uncut) stems. The segments are cut to have at least 2 buds to assure germination, because not every bud germinates. Current machines used to cut sugar cane segments are not able to identify any characteristic in the stem, and therefore the precise position of the cut sites is determined at random.

After cutting, the setts are disposed horizontally, over one another in furrows of the ploughed soil, which are generally wide at ground level and deep (40 to 50 cm wide and 30 to 40 cm deep), and then lightly covered with soil.

Although this plantation technique is still being used until today, the whole process is relatively inefficient, because many segments each having 2-4 nodes, have to be used to guarantee the germination. The consequence is that a large area for re-planting needs to be used, and therefore the area that could be employed for the crop and production of alcohol or sugar has to be reserved for re-planting. Thus, there is a necessity to increase the efficiency of the planting technique of sugar cane.

With the current technique, the sugar cane stems are randomly cut usually to a length of between approximately 20 cm and 50 cm, a length guaranteed to comprise 2-4 nodes. This is because buds do not emerge at all nodes. However, it has been found that, when treated with certain fertilizers and other compounds before planting, germination of a bud is possible from a short stem section having a single node.

Consequently, it is desired to increase the planting and germination efficiencies of graminaceous plants, especially sugar cane, by reducing the number of nodes in each stem segment. It is also desired to identify certain characteristics of the stem by avoiding the planting of damaged buds or segments, including stems that are damaged, diseased or rotten, in order to improve the germination efficiency of the plants.

Although cutting the stem with one node and without damage to it could be done manually, the productivity would be small and/or it would be necessary to employ a large number of people just to cut the stems, naturally increasing the plantation process costs.

Therefore, it is also desired to provide an automated and controlled method to select stem segments with desired characteristics, particularly those segments comprising one bud without damage. It is an additional objective to select stem segments comprising an undesired characteristic, such as the presence of a disease, pest, or rotten segments, in order to avoid the re-planting of such segments that are unlikely to have a viable bud.

Japanese Patent Application Publication Number 4-258300 describes a system for sorting sugar cane stems according to stem thickness, using an optical sensor technology. However, optical sensors require that the stem sections are clean of all leaf tissue to enable accurate detection of nodes or buds. The process of cleaning stem sections is time consuming, and can damage buds developing at the nodes. Also, optical sensors can only detect differences in the stem that are externally visible, and so are not suitable for detecting the presence of diseased, rotten or pest infested stems.

### BRIEF DESCRIPTION OF THE DRAWINGS

The invention will now be described in relation to a particular embodiment with reference to the attached drawings, wherein:

FIGS. 1 to 5 are graphics that demonstrate the identification of a characteristic in the stem; and

FIG. 6 is a block diagram showing an exemplificative embodiment of a sensor set.

### DESCRIPTION OF THE INVENTION

To achieve the above-mentioned objectives, among others, it is proposed a method to cut and select stem segments comprising at least one characteristic. The method, according to an embodiment of the invention, comprises the steps of identifying at least one characteristic of a stem segment by a sensor; and separating the stem segments comprising the said characteristic from those which do not comprise the said characteristic, depending on the response of said identification means; characterized in that the sensor is selected from the group consisting of a pressure transducer sensor, a capacitive sensor, an ultrasound sensor, an x-ray sensor, a magnetic sensor, and a microwave sensor.

According to the method of the invention, the first step involves the identification of at least one characteristic of the segment by a sensor. By “identification of at least one characteristic of each the stem segment” shall be interpreted that one or more than one characteristic in the stem segment may be identified by an identification means.

One of such characteristics may be the presence of a node or bud in the stem segment. Other characteristics may also be identified by a sensor, such as the presence of damage or disease for example caused by pests, or rotten sections of stem. Examples of pests that attack graminaceous plants, and particularly sugar cane, are:
Larvae such as Diatraea saccharalis and Telchin licus licus.
Plant lice such as Rhopalosiphum maidis and Melanaphis sacchari.
Beetles such as Migdolus fryanus; Sphenophorus levis; Diloboderus spp; Euetheola spp; Ligynus spp, Stenocrates spp, Phytalus spp; Phyllophaga spp etc and several species of the Scarabaeidae family.
Termites such as those from the Termitidae family, Cornitermes genus (e.g. C. cumulates); and those from the Rhinotermitidae family (e.g. Heterotermes tenuis and H. longiceps).
Nematodes such as Meloidogyne spp, Helycotilenchus spp. and Pratylenchus spp.
Caterpillars such as Elasmopalpus lignosellus, Spodoptera frugiperda and Mocis latipes.
Cicadas such as Notozulia entreriana, Deois schach, Aeneolamia selecta, Deois flavopicta, Mahanarva fimbriolata, Mahanarva posticata, and Kanaina vittata.

Such pests may cause a modification in the stem structure. Such modification in the structure of the stem may be empirically detected by an identification means. Alternatively, the stem may be rotten, and its internal structure may also be damaged. In any case, such undesired characteristic may also be detected by a sensor.

Therefore, the presence of at least one characteristic, whether it be a desired characteristic such as the presence of the node or bud in the stem, or an undesired characteristic such as the presence of a damaged, diseased or a rotten segment, may be detected by a sensor, to separate those segments with the desired characteristic from those segments which do not comprise such desired characteristic.

Alternatively, more than one characteristic may be identified in the segment, simultaneously. For example, the sensor may identify a desired characteristic in one segment, such as the presence of a node, and concomitantly identify an undesired characteristic in the segment, such as the presence of a diseased or a rotten segment. Even if the segment comprises a desired characteristic, the simultaneous presence of an undesired characteristic could result in separation of the segment from those which only comprise the desired characteristic.

The identification step is carried out using a sensor as an identification means. The sensor is selected from the group consisting of a pressure transducer sensor, a capacitive sensor, an ultrasound sensor, an x-ray sensor, a magnetic sensor, and a microwave sensor. In one embodiment, the sensor is selected from the group consisting of an x-ray sensor, a microwave sensor and a electromagnetic sensor. In another embodiment, the sensor is an x-ray or magnetic sensor. In one embodiment, the sensor is a microwave sensor. In another embodiment, the sensor is an x-ray sensor. In another embodiment, the sensor is a magnetic sensor. Suitably, the magnetic sensor is an electromagnetic sensor.

The sensors may be empirically adjusted to generate a response when a segment of the stem comprises an identifiable characteristic. Such characteristic may be the presence of the node in the stem.

When an electromagnetic sensor is used, for example, the node can be identified in the stem by a variation in the electromagnetic waves captured by the sensor in an electromagnetic field. As known by those skilled in the art, different materials or elements cause different responses to the electromagnetic waves in an electromagnetic field. The electromagnetic waves reflecting from a certain material can be transformed into a pattern that enables a certain characteristic of the material to be identified. That is the principle of the electromagnetic resonance machines used in the diagnoses of human body internal tissues, for example.

Using an electromagnetic sensor, the magnetic resonance frequency is measured between two metallic surfaces and frequency is interpreted by a transducer. Particularly with sugar cane, the node is more rigid and comprises less water than the average rigidity and water content of the rest of the stem. Therefore, a node can be identified using an electromagnetic field, since its lower water concentration and higher rigidity (fiber content) will cause a different electromagnetic wave response with respect to the rest of the stem. Damaged, diseased or rotten stem sections can also be detected since these also exhibit a different fiber and water content compared to the rest of the stem.

The sensor employed may be also an x-ray or microwave sensor, wherein such sensors will have different responses with respect to particular characteristics along the length of the stem. For example, the x-ray sensor may detect a different concentration or type of organic tissues in the node. The microwave sensor may have a different response due to the lower water concentration in the node, since microwaves are responsive to water molecules.

The same principle may be used to identify a damaged segment, a rotten segment or the presence of a disease or pest in a segment.

In a particular embodiment of the present invention, the description below relates to the use of an electromagnetic sensor.

To generate a digital data output (that will be used by a PLC or CNC to control the machine), depending on the response of the sensor reading, the sensor (24) is connected to a set that has the function of generating the electromagnetic field and also collecting and interpreting the data generated by the sensor reading.

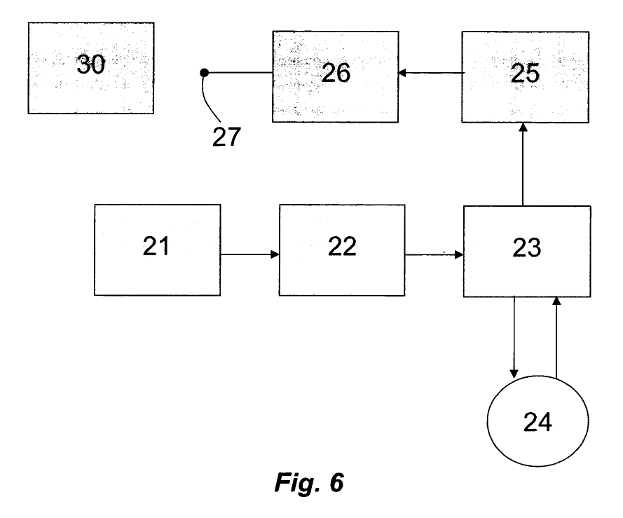

An example of a sensor set is schematically represented in FIG. 6. As will be appreciated by those skilled in the art, this sensor set is an example of an embodiment, and many variations may be developed to produce digital data depending on the sensor reading.

This set according to this embodiment comprises a frequency generator (21), a transformer (22), a frequency filter (23), a signal amplifier (25), a programmable digital processor (26) and a digital output (27). The high-frequency generator (21) may be any suitable means to generate a high-frequency sinusoidal electrical wave capable of producing an electric field and consequently a magnetic field in the sensor, as will be explained in more details below. The sinusoidal wave may be an alternated electric current, preferably having a relative high voltage and low current. The current and voltage may be determined empirically by those skilled in the art depending on the response of the electromagnetic waves to the characteristics of the sugar cane stem which are desirous to be identified.

As frequency electric generators (21) usually produce a relative low voltage, optionally a set-up transformer (22) may also be employed after the frequency generator in order to increase the voltage.

It has been observed that a voltage between about 10 and 2,000 Vpp (Volts peak to peak), particularly between about 50 and 1,500 Vpp, and more particularly around 150 Vpp is suitable to produce an electromagnetic field in the sensor to identify a characteristic in the stem. The current set in a range between about 50 and 500 mA (milli Amperes), particularly between about 100 and 250 mA, and more particularly around 200 mA has also proved to be suitable to identify a characteristic in the stem. The frequency used in the generator may also be determined by a man skilled in the art, and according to this embodiment a suitable frequency is set between about 800 kHz and 7.2 MHz, particularly between about 1 MHz and 3 MHz, and more particularly about 2 MHz.

Such ranges are exemplificative, and the voltage, current and frequency may be empirically determined by those skilled in the art, depending on the species of the stem and the characteristic desired to identify.

The set-up transformer (22), as mentioned above, may be used to increase the voltage produced by the frequency generator. The transformer may increase the current as necessary to achieve the desired voltage, depending on the voltage output of the generator. For example, the transformer may increase the voltage by 1 up to 20 times, and more particularly by about 15 times if the signal generated by the high-frequency generator has about 10 Vpp. The amplified signal in the output of the transformer will have about 150 Vpp, taking into consideration the ranges mentioned above.

As may be realized by those skilled in the art, the transformer may be suppressed if the current and voltage generated by the generator is suitable for the purposes of creating a detectable electromagnetic field in the sensor, particularly within the ranges of voltage, current and frequency exemplified above.

The signal coming from the generator and transformer is injected in a frequency filter (23), the function of which, as those skilled in the art will appreciate, is to identify the variation in the electromagnetic waves generated and detected by the sensor.

Due to the varying physical characteristics of sugar cane, in particular the variations in stem length and diameter (sugar cane stems are rarely rectilinear), the use of a sensor as described above has proved to be efficient in detecting a desired stem characteristic.

Suitably, the sensor comprises at least two metallic surfaces between which the sugar cane stem passes. The distance between the surfaces may vary to accommodate variations in stem diameter. The surfaces may take any conformation, such as plates, bars, blocks, discs, cylinders or the like. Optionally the surfaces may apply a pressure to the stem as it is passing between them, so that the stem touches both surfaces. This facilitates detection of the node—for example if a pressure sensor is used, slight movement of one or both of the surfaces will be detected when a node passes between them, since the stem diameter is slightly wider at the position of a node, that protrudes slightly from the rest of the stem. The pressure may be applied via any suitable mechanism, such as springs, compressed air, hydraulic pressure or the like. In one embodiment, said surfaces may be in the form of cylinders. Optionally, at least one of said cylinders has a frustoconical shape to facilitate entry of the sugar cane stem into the sensor unit and align it between the surfaces.

In one embodiment, the electromagnetic sensor has a body of cylindrical shape and is formed by a plurality of metal electrodes, made of metallic thin plates that generate the electromagnetic field. The electrodes are fixed at one end in a regularly spaced manner around the perimeter of the cylindrical body, which is preferably made of insulating material (such as a polymer) to avoid interference with the electromagnetic field, while the other end of the electrodes have free ends which will allow the sugar cane stem to pass through.

In another embodiment, the electromagnetic sensor is formed by two metallic cylinders between which the sugar cane stem (40) passes. When the sugar cane node passes between the cylinders, there is a small variation in the electromagnetic wave response, which can be detected and used to confirm the presence or absence of a node.

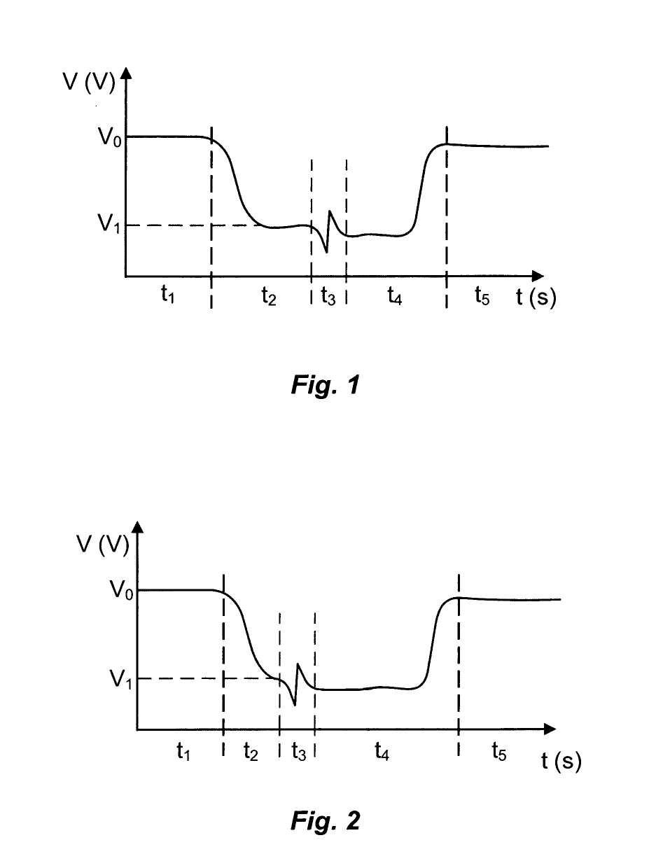

FIG. 1 discloses an example of wave pattern graphic using an electromagnetic sensor to identify a desired characteristic in a stem segment, being this characteristic the presence of a node in the segment of a sugar cane stem.

This graphic shows the variation in the voltage with time, when a sugar cane stem is passing by an electromagnetic sensor. At t₁, no sugar cane stem is passing through the sensor, and the voltage V₀ is higher. When the segment begins to pass through the sensor, the voltage decreases (V₁ at t₂) and the node, containing less water than the average content of the stem and being more rigid, causes a perturbation in the wave, which can be detected at t₃. After the passage of the node, the signal stabilizes at t₄ and the voltage increases again when the segment leaves the sensor at t₅.

This exemplificative wave pattern was described in relation to a stem comprising only one node. As will be appreciated by those skilled in the art, for a stem section that comprises more than one node, the pattern t₂ to t₃ will repeat until the end of the stem section, finishing at t₅.

After the signal exemplified in FIG. 5 is separated in the filter (23), the wave pattern may be amplified, converted into an analog derivative signal (FIG. 4), and converted into a digital signal to generate a digital data output (27) (FIG. 5). The digital data output (27) may be generated by a programmable processor (26), which is used to interpret the analog signal, convert it into a digital signal to produce a digital data representative of a characteristic of the stem which is desired to identify, such as the node in this explanative example. The digital data output (27) is connected to a PLC or CNC (30) that controls the sorting process of desired stem segments from undesired stem segments.

The wave pattern may be used to identify the segments comprising one node, which is desired to be used for sugar cane planting, for example.

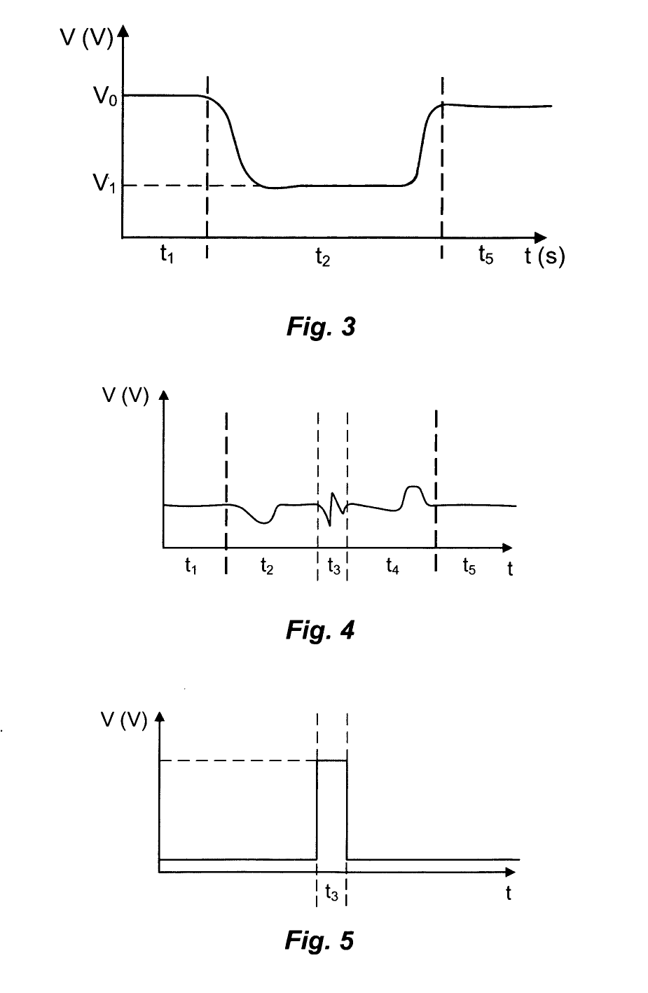

Other patterns, for example as disclosed in FIGS. 2 and 3, respectively, illustrate wave patterns of characteristics that may indicate undesirable stem segments. For example, FIG. 2 exemplifies a segment that comprises a node near to its edge—such a node may be damaged by the cutting process and therefore the segment is not suitable for planting since it is unlikely to produce a viable bud. FIG. 3 exemplifies a segment that does not comprise a node, and so it also unsuitable for planting.

Therefore, based on such patterns that may be empirically determined, it is possible to generate a response of segments that are desired to select. It is important to select desirable stem segments from undesirable stem segments to ensure that only segments with a high likelihood of having viable buds are planted, this maximizing the efficiency of the planting process.

The sensor response and the sensor set generates an electrical signal, such as a digital signal output (27) for example, and sends this signal to controlling means (30), such as a PLC or CNC, that will control separating means to separate the segments. Such separating means may be any suitable means to separate those segments comprising the desired characteristic from those which do not comprise said characteristic. Such separating means may be for example, but without limitation, a pneumatic cylinder conveying the segments to different paths in order to separate them depending on the sensor's response. Even hydraulic cylinders may be employed, or electric driven rods, to convey the segments to different paths to separate them. The separation means may be determined by those skilled in the art.

In an alternative embodiment, the method of the invention further includes an additional step prior to identification of the stem segments, that being cutting of the stem into segments having a predetermined length. As mentioned above, the stem may be the stem of a graminaceous plant, such as bamboos (Bambusoideae, e.g. Phyllostachys spp, and Arundinaria spp); sugar cane (Saccharum spp), and other grasses (such as elephant-grass (Pennisetum purpureum). Suitably, the graminaceous plant is sugar cane.

The cutting may be done manually or mechanically, by automated means. The cutting is preferably done by automated means. The sugar cane harvesting machines, besides harvesting the stems from the soil, usually tear away the leaves and cut the stems to a predetermined length. The harvesting machine may be adjusted to control the cutting length of the segments. Cutting may take place at the time of harvest, or later. For example, the present invention may be used in accordance with existing harvesting technology, wherein the harvested segments are subsequently cut into shorter stem segments and sorted into those that are desired and those not desired.

In an alternative embodiment, the method of the invention further includes an additional step prior to identification of the stem segments, that being cutting of the stem into segments at random, i.e. the cutting step does not involve the definition of any parameter besides the length of the segments of the sugar cane stem that is cut. If the cut is performed randomly, some segments will comprise buds, some not and some buds will be damaged by the cutting.

The length of the segment may vary according to specific requirements, such as the type of the sugar cane or the characteristic it is desired to be comprised in the stem. Particularly, this characteristic is the presence of a node in the stem segment.

As mentioned above, the presence of a single node in the stem segment may be useful to improve the germination and planting efficiency of graminaceous plants, particularly sugar cane, when the segment is treated with adequate fertilizers and other compounds.

Therefore, the length of the segment shall be a sufficient length to allow the germination of the bud in the segment. It has been observed that a segment from about 2 to about 12 cm, particularly from about 3 to about 8 cm, more particularly from about 3.5 to about 4.5 cm, and preferably about 4 cm, is suitable to guarantee the germination of the bud in a segment. The precise segment length is not critical, and the lengths above may be interpreted as approximate.

It has also been empirically observed that when the segments are cut within the above-mentioned range, the loss of segments (segments that do not comprise a bud or segments that comprise a damaged bud due to the random cutting) is about 60%. This means that around 60% of the stem whole length is lost, either by not comprising at least one bud or by comprising a damaged bud. The other 40% are stem segments comprising at least one bud.

In another embodiment, when an electromagnetic sensor is used in the method of the present invention, water is applied to the stem segments before passing through the sensor, in order to enhance the electrical conductivity of the stem and thus the identification of a desired or undesired characteristic in the stem. Wetting of the stems may be achieved, for example, by spraying them with water or passing them through a water bath prior to sensing and cutting.

The present invention may use any suitable means to cut the stem. For example, the cutting means may include one or more knives, scythes, circular saws, plasma or laser cutting systems. Suitably, the cutting device is high throughput to allow rapid cutting of stems. To improve cutting throughput, more than one cutting device may be employed simultaneously to cut multiple stems at the same time, or to make multiple cuts of a single stem at the same time. Activation of the cutting device may be by any suitable means, for example servomotors, pneumatic cylinders, hydraulic cylinders, and the like.

In another alternative embodiment, before the identification step the stem segments may be conveyed either vertically or horizontally in a conveying belt, for example, to place the segments aligned one after another. The alignment may facilitate the subsequent step of identifying the stem segments with at least one characteristic.

As can be realized by those skilled in the art, the method of the present invention may increase the productivity and the efficiency of planting graminaceous plants, particularly sugar cane, since it permits an automated process to identify stem segments comprising one node and/or separate segments that comprise an undesired characteristic, such as the presence of a disease, pests or rotten segments.

It must be understood that although the invention has been described in relation to a particular embodiment, those skilled in the art may develop many technical and construction variations without deviating from the scope of the present invention. Therefore, the annexed claims shall be interpreted as covering all the equivalents that are within the scope and character of the present invention.

1. A method of selecting stem segments, characterized by comprising the steps of:
identifying at least one characteristic of a stem segment by a sensor; and
separating the stem segments comprising the said characteristic from those which do not comprise the said characteristic, depending on the response of said identification means;
characterized in that the sensor is selected from the group consisting of a pressure transducer sensor, a capacitive sensor, an ultrasound sensor, an x-ray sensor, a magnetic sensor, and a microwave sensor.

2. A method according to claim 1, wherein said stem segment is from a sugar cane (Saccharum spp) stem, a bamboo (Bambusoideae) stem, or an elephant-grass plant (Pennisetum purpureum) stem.

3. A method according to claim 1, wherein said characteristic identified in the stem segment is the presence of a node in the segment.

4. A method according to claim 1, wherein said characteristic identified in the stem segment is damage, the presence of disease or pests, or a rotten segment.

5. A method according to claim 1, wherein more than one characteristic is identified simultaneously.

6. A method according to claim 1, wherein it further comprises the step of cutting a stem into segments having a predetermined length before the identification step.

7. A method according to claim 1, wherein it further comprises the step of cutting a stem into segments at random before the identification step.

8. A method according to claim 6, wherein the stem segments are cut in to a length from 2 to 12 cm, particularly from 3 to 8 cm, and more particularly about 4 cm.

9. A method according to claim 1, further comprising the step of wetting the stem segments before identifying the characteristic of the stem segment.

10. A method according to claim 1, wherein said sensor is an x-ray sensor.

11. A method according to claim 1, wherein said sensor is a magnetic sensor.

12. A method according to claim 11, wherein said sensor is an electromagnetic sensor.

13. A method according to claim 1 further comprising the step of conveying and aligning the segments before the identification step.

14. A method according to claim 1, wherein the separation step uses a pneumatic cylinder, or a hydraulic cylinder or driven rods to convey the segments to different paths depending on the response of said identification means.
